(19) United States
(12) Patent Application Publication
(10) Pub. No.: US 2004/0188033 A1
(43) Pub. Date: Sep. 30, 2004

(54) Carpet stripping device

(76) Inventor: Dale Marizzaldi, Pittsburgh, PA (US)

Correspondence Address: High Technology Patents, Inc., 3825 Green Valley Dr., Pittsburgh, PA, 15235, US

(21) Appl. No.: 10/402,422

(22) Filed: Mar. 28, 2003

(51) Int. Cl. B32B 1/00

(52) U.S. Cl. 156/584

(57) ABSTRACT

The present invention is a blade for a carpet stripping apparatus, the blade being for attachment to a rotor of the carpet stripping apparatus. The blade comprises integral teeth for penetrating the carpet whereby a stripping force may be applied to the carpet by rotation of the rotor.

### CROSS REFERENCE TO RELATED APPLICATIONS

The present invention was first described in Disclosure Document No 496,485, filed on Jul. 2, 2001.

### FIELD OF THE INVENTION

The present invention relates, in general, to carpet removing equipment and, more particularly, the present invention relates to equipment for removing carpet that has been attached to a floor by an adhesive.

### BACKGROUND OF THE INVENTION

In commercial and industrial applications, carpet is typically attached to the floor by strong industrial adhesives. When it is necessary to remove the carpet, due to wear or remodeling, considerable effort is required. Typically, removal is accomplished by a number of personnel, working in unison, pulling the carpet by hand. The physical demand usually causes severe strain on back and arm muscles.

U.S. Pat. No. 5,415,725 teaches a motorized machine having rollers driven by a gearbox connected to the motor. A tab of carpet is ripped up and inserted between rollers. Application of force to a pair of leverage arms compresses the carpet so that rotation of the rollers rips the carpet from the floor and causes the machine to move.

U.S. Pat. No. 4,394,052 teaches a motorized machine having a blade that slides under the carpet to detach the carpet from the floor and cut the edges of a strip of carpet being removed. Carpet is wound around a spool in the machine. To move across the floor, the machine pulls a cable attached to a floor anchor. Furthermore, contact between the blade and the floor may dull the blade and damage the floor. Concrete floors may be broken up, or wood floors may be gouged by the blade.

U.S. Pat. No. 6,004,426 teaches a machine having a spool member made of polyvinyl chloride (PVC) pipe with a row of radial screws for engaging the carpet. This system does not appear to have the required strength for carpet that is strongly bonded to the floor, the screws tending to snap or break, or rip out of the PVC pipe. The spool is turned by a chain drive energized by a motor. The system has hazards due to pinch points or the possibility of a chain breaking under load. In a manual version, the spool is turned by levers attached to its axis at its ends and engaging notches in the ends of the spool.

U.S. Pat. No. 6,386,476 is a manual carpet removal tool. It has a longitudinally split cylinder having a length equal to the width of a strip of carpet that is to be removed. The two halves of the longitudinally split cylinder are hinged to each other along one split, so that a gap may be opened along a split opposite the hinged split. An edge of the carpet is placed in the gap and the two halves are clamped onto the carpet to engage it. After the carpet is secured between the two halves of the split cylinder, the split cylinder is rotated by a wrench applied to one end of the split cylinder. One difficulty of this design is that the split cylinder has very poor torsional stiffness. It is therefore necessary for the split cylinder to be quite heavy to have the required torsional stiffness.

### INTRODUCTION TO THE INVENTION

Apparently, there is a need in the art for a carpet removal apparatus that is lightweight, economical to manufacture, quiet and which can operate without damaging floors or being damaged.

It is one of the primary objectives of the present invention to provide an apparatus for removing carpet that is bonded to a floor.

Another objective of the present invention is to provide an apparatus for removing carpet that can be easily carried by one person.

An additional objective of the present invention is to provide an apparatus for removing carpet that can be employed by one person.

Still another objective of the present invention is to provide a carpet removal system that is relatively economical to manufacture.

Yet another objective of the present invention is to provide an apparatus for removing carpet that is bonded to a floor Pith less damage to the floor than some prior art equipment.

It is an additional objective of the present invention to provide a carpet removal apparatus that does not require a motor.

Still yet another objective of the present invention is to provide a carpet removal apparatus that does not require floor anchors or cables.

Yet still another objective of the present invention is to provide a carpet removal apparatus for removing carpet that is bonded to a wood floor without gouging the floor.

An additional objective of the present invention is to provide a carpet removal apparatus that can be employed in confined spaces.

Another objective of the present invention is to provide a carpet removal apparatus that operates quietly.

Yet still another objective of the present invention is to provide a carpet removal apparatus that is generally free of electrical or mechanical hazards.

A further objective of the present invention is to provide a carpet removal apparatus that can easily be engaged with the carpet at the beginning of the process.

An additional objective of the present invention is to provide a carpet removal apparatus that requires a minimum of kneeling or stooping.

In addition to the various objectives and advantages of the present invention which have been generally described above, there will be various other objectives and advantages of the invention that will become more readily apparent to those persons who are skilled in the relevant art from the following more detailed description of the invention, particularly, when the detailed description is taken in conjunction with the attached drawing figures and with the appended claims.

### SUMMARY OF THE INVENTION

In one aspect, the present invention is an apparatus for removing carpet adhered to a floor. The apparatus includes an elongate rotor and also includes a toothed blade attached to the elongate rotor. The toothed blade comprises a plurality of teeth for engaging the carpet. The apparatus further includes at least one ratchet assembly, the ratchet assembly being employable to apply torque to the rotor thereby stripping the carpet from the floor.

In another aspect, the present invention is a toothed blade for a carpet stripping apparatus, the toothed blade being for attachment to a rotor of the carpet stripping apparatus. The toothed blade comprises teeth for penetrating the carpet whereby a stripping force may be applied to the carpet by rotation of the rotor.

### BRIEF DESCRIPTION OF THE DRAWINGS

FIG. 1 is a perspective drawing of a presently preferred embodiment of the present invention.

FIG. 2 is an exploded view of the embodiment shown in FIG. 1.

FIG. 3 is an end view of the rotor and angled, toothed blade of the invention, and carpet engaged by the angled, toothed blade being stripped from the floor.

FIG. 4 is a sketch of the ratchet wrench and shows the ratchet stem that communicates torque to the rotor.

FIG. 5 is a sketch showing a forward/reverse lever on the ratchet wrench whereby the ratchet wrench may be employed at either end of the rotor.

FIG. 6 is a schematic cross section of the rotor of an alternative embodiment employing a flat, toothed blade attached to a quadrate tube.

FIG. 7 is a schematic cross section of the rotor of an alternative embodiment employing a flat, toothed blade attached to a round tube.

FIG. 8 is a detailed sketch of the teeth of the angled, toothed blade, according to the presently preferred embodiment of the present invention.

FIG. 9 is a detailed sketch of the teeth of the flat, toothed blade, according to an alternative embodiment of the present invention.

### IDENTIFYING NUMERALS EMPLOYED IN THE DRAWINGS

1 Quadrate tube

2 Angled, toothed blade

3 Ratchet assembly

4 Ratchet head assembly

5 Elongate rotor with quadrate tube and angled blade

8 End plate

10 Carrying strap

12 Receiver for ratchet stem

13 Teeth

14 Carpet

15 Elongate rotor with flat, toothed blade

16 Screws

17 Handle extension

18 Ratchet wrench

19 Ratchet stem

20 Weld

21 Ratchet housing

22 Forward and reverse lever

23 Radial line

24 Center

25 Reference line

26 Round tube

27 Angle between toothed blade and radial line

29 Round end plate

30 Elongate rotor with round tube and flat, toothed blade

32 Flat, toothed blade

33 Notches

34 Length of teeth

35 Pitch of teeth

36 Angle of angled, toothed blade

40 Apparatus for removing carpet

### BRIEF DESCRIPTION OF THE PRESENTLY PREFERRED AND VARIOUS ALTERNATIVE EMBODIMENTS OF THE INVENTION

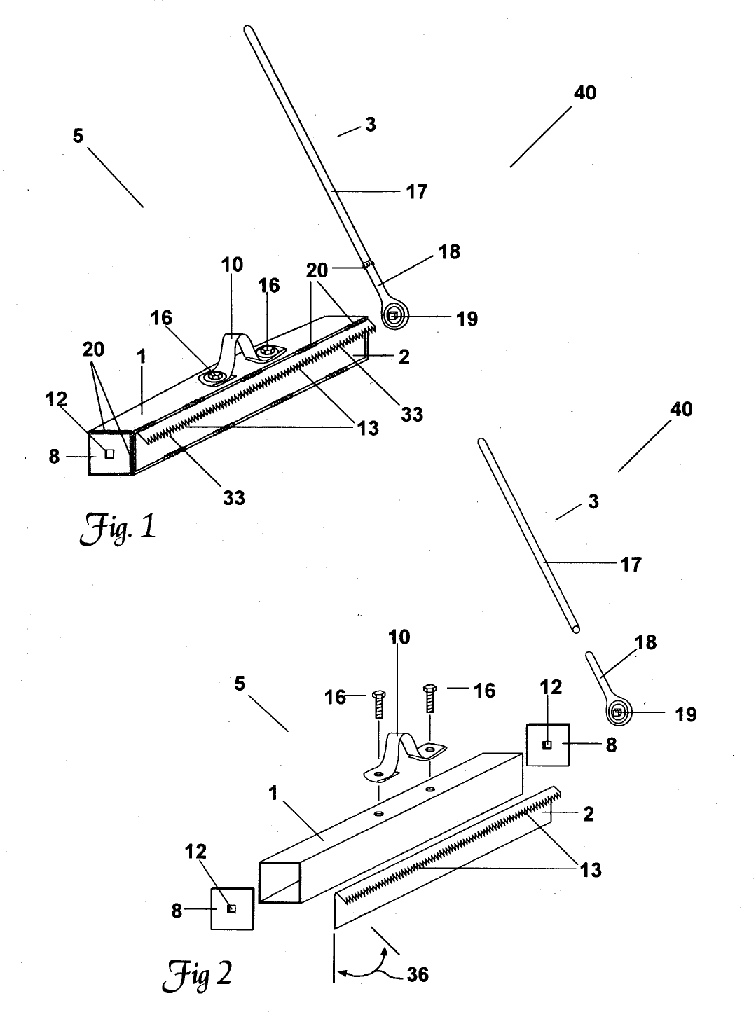

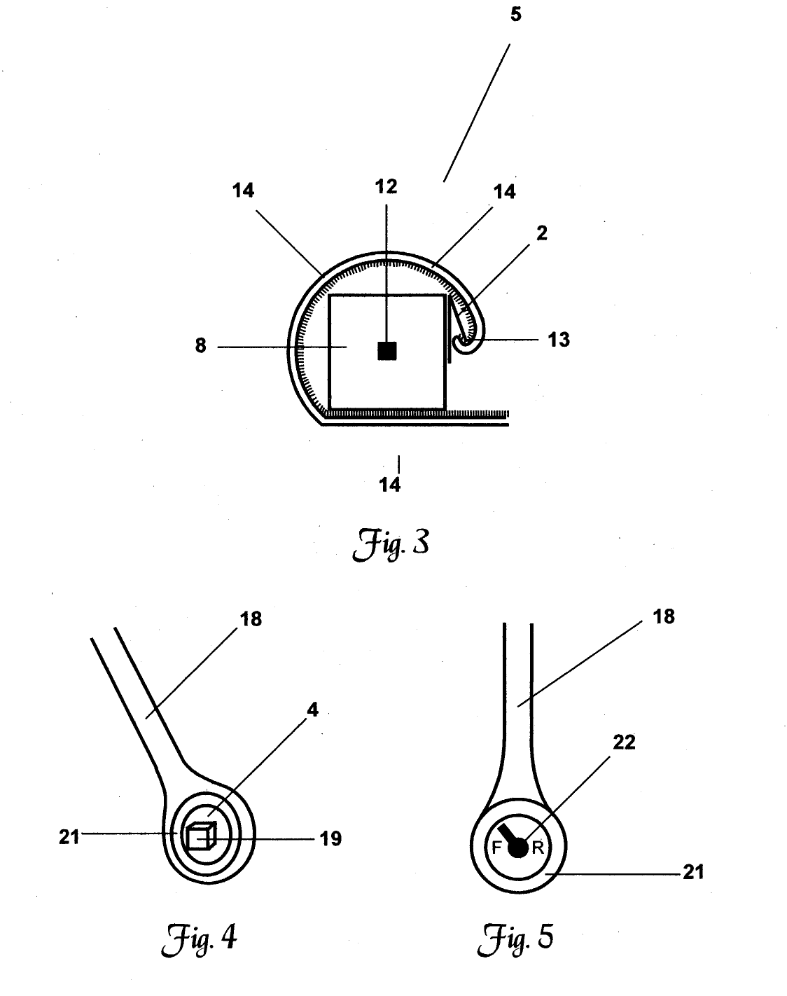

Attention is directed to FIG. 1 that illustrates a carpet remover, generally designated 40, according to a presently preferred embodiment of the invention. Carpet remover 40 has an elongate rotor 5 that, preferably, has a length equal to the width of a strip of carpet to be removed. Elongate rotor 5 includes a quadrate tube 1 having an angled, toothed blade 2 attached thereto. Angled, toothed blade 2 has teeth 13 with notches 33 therebetween. The teeth 13 of angled, toothed blade 2 are for penetrating and gripping the carpet 14, as shown in FIG. 3. FIG. 3 shows the elongate rotor 5 after teeth 13 of angled, toothed blade 2 have been pushed into carpet 14 followed by a clockwise rotation of elongate rotor 5 through 270 degrees. Angled, toothed blade 2 is bent, as shown, to angle 36, that is, preferably, about 30 degrees.

Ratchet assembly 3 is employed to apply torque to elongate rotor 5 whereby elongate rotor 5 rotates and carpet 14 is stripped from the floor and wound around quadrate tube 1 of elongate rotor 5, as shown in FIG. 3. FIG. 2 is an exploded view of carpet remover 40.

In this presently preferred embodiment, quadrate tube 1 is approximately 7.5 cm on a side and approximately 3 mm wall thickness. (This is about 3″ on a side and 1/8″ wall.) It is, preferably, about 122 cm long. (Four feet.) It is made of low carbon steel, for example, A 36 steel. End plates 8 are, preferably, attached to the ends of quadrate tube 1 by electric stitch welds 20.

End plates 8, preferably, include ratchet engaging means 12 whereby ratchet assembly 3 may apply torque to rotor 1. Preferably, the ratchet engaging means 12 in each of end plates 8 comprises a square hole which is approximately 1.9 cm on a side (Three fourths of an inch.) It is presently preferred that end plates 8 be made of T-1 carbon steel. Preferably, end plates 8 are attached to quadrate tube by electric stitch welds 20. Likewise, angled, toothed blade 2 is attached to quadrate tube 1 by electric stitch welds. Preferably, elongate rotor 5 has a carrying strap 10 which is attached to quadrate tube 1 by screws 16.

FIGS. 1 and 2 illustrate the construction of ratchet assembly 3. Ratchet assembly 3 comprises ratchet wrench 18 with a handle extension 17 attached by electric stitch weld 20. Handle extension 17 is, preferably, a schedule 40 pipe approximately 90 cm long (three feet). Ratchet stem 19 is for engaging ratchet engaging means 12 in end plate 8.

FIGS. 4 and 5 provide additional detail concerning ratchet wrench 18. Ratchet wrench 18 comprises ratchet head assembly 4 having internals (not shown) disposed in ratchet housing 21. Ratchet stem 19 is driven in a single direction that is selected by forward and reverse lever 22. Ratchet wrench 18 is an off the-shelf item known in the United States as a ¾″ drive wrench.

By employing the forward and reverse lever 22, the ratchet assembly 3 may be employed at either end of elongate rotor 5. To exert additional torque on elongate rotor 5, two of ratchet assembly 3 may be employed at the ends of elongate rotor 5. Two persons may thereby cooperate to exert the additional torque.

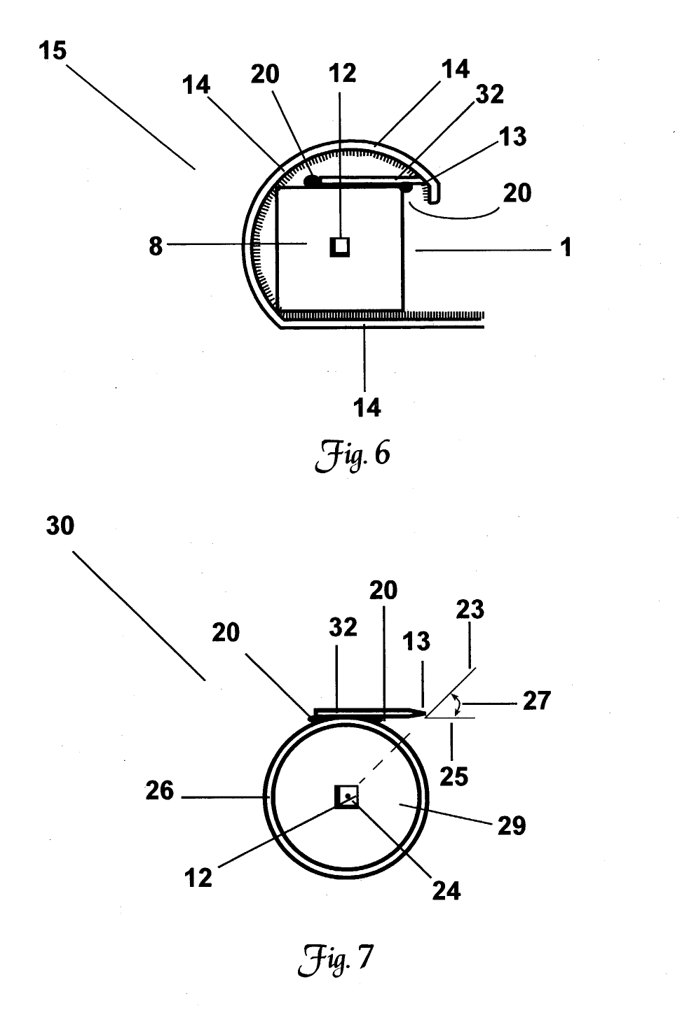

FIG. 6 illustrates an alternative design for the present invention, wherein elongate rotor 15 replaces the elongate rotor 5 shown-in FIGS. 1 through 3. Elongate rotor 15 comprises a quadrate tube 1 with a flat, toothed blade 32 attached thereto. Elongate rotor 15 includes end plates 8. Flat, toothed blade 32 has teeth 13 that are similar to the teeth 13 of angled, toothed blade 2. FIG. 6 shows the elongate rotor 15 and carpet 14 after teeth 13 of flat, toothed blade 32 have been pushed into carpet 14 followed by a clockwise rotation of rotor 15 through 180 degrees. Preferably, flat, toothed blade 32 is attached to quadrate tube 1 by electric stitch welds 20.

FIG. 7 illustrates an alternative design for the present invention, wherein elongate rotor 30 replaces the elongate rotor 5 shown in FIGS. 1 through 3. Elongate rotor 30 comprises a round tube 26 with a flat, toothed blade 32 attached thereto. Elongate rotor 30 includes round end plates 29. FIG. 7 shows the elongate rotor 30 and carpet 14 after teeth 13 of flat, toothed blade 32 have been pushed into carpet 14 followed by a clockwise rotation of rotor 30 through 180 degrees. Preferably, flat, toothed blade 32 is attached to round tube 26 by electric stitch welds 20.

FIG. 7 also illustrates a preferred angular relationship of teeth 13 to a radial line 23 drawn from the center 24 of elongate rotor 30. In FIG. 7, reference line 25 is parallel to the plane of teeth 13. The angle 27 between reference line 25 and radial line 23 is, preferably no less than about 40 degrees.

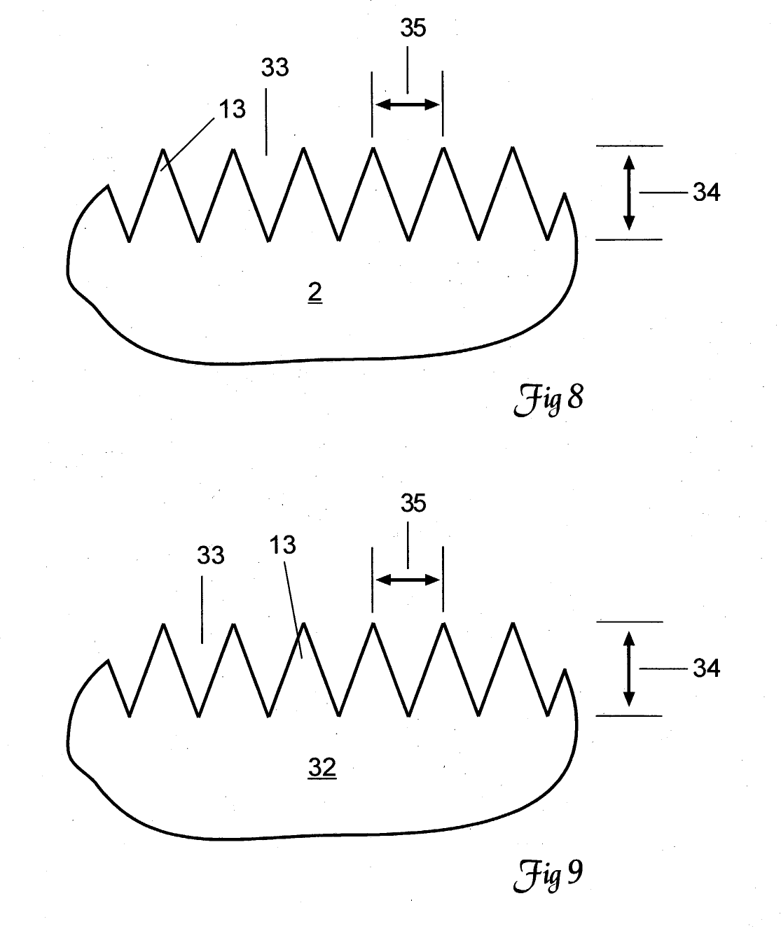

FIG. 8 is a detail showing the presently preferred configuration of teeth 13 and notches 33 of angled, toothed blade 2. In this presently preferred embodiment, teeth 13 have a length 34 of about 0.635 cm (¼″). The pitch 35 of teeth 13, preferably, is about 0.476 cm (3/16″). Angled, toothed blade 2 is, preferably, about 0.19 cm thick (14 gage). Preferably, it is mild steel.

FIG. 9 is a detail showing the configuration of teeth 13 and-notches 33 of flat, toothed blade 32. In this embodiment, teeth 13 have a length 34 of about 0.635 cm (¼″). The pitch 35 of teeth 13, preferably, is about 0.476 cm (3/16″). Flat, toothed blade 2 is, preferably, about 0.19 cm thick (14 gage). Preferably, it is mild steel.

While the presently preferred and various additional alternative embodiments of the instant invention have been described in detail above in accordance the patent statutes, it should be recognized that various other modifications and adaptations of the invention may be made by those persons who are skilled in the relevant art without departing from either the spirit or the scope of the appended claims.

1. An apparatus for removing carpet adhered to a floor, said apparatus comprising:
an elongate rotor;
a blade attached to said elongate rotor, said blade comprising a Plurality of integral teeth, said teeth being for engaging said carpet; and
at least one ratchet assembly, said at least one ratchet assembly employable to apply torque to said rotor thereby stripping said carpet from said floor.

2. An apparatus, according to claim 1, wherein said at least one ratchet assembly comprises two ratchet-assemblies disposed or disposable at opposite ends of said elongate rotor, whereby two persons may employ said ratchet assemblies to apply torque to said elongate rotor.

3. An apparatus, according to claim 2, wherein said two ratchet assemblies are of similar manufacture and each comprises a forward and reverse lever whereby either of said two ratchet assemblies is employable at either end of said rotor.

4. An apparatus, according to claim 1, wherein said rotor comprises at least one end plate.

5. An apparatus, according to claim 4, wherein said at least one ratchet assembly comprises a ratchet stem, and said at least one end plate comprises a ratchet engaging means for engaging said ratchet stem.

6. An apparatus, according to claim 5, wherein said ratchet stem is square and said ratchet engaging means comprises a square hole in said at least one end plate.

7. An apparatus, according to claim 1, wherein said rotor further comprises two end plates disposed at opposite ends of said rotor, each of said two end plates comprising ratchet engaging means for engaging said at least one ratchet, whereby torque may be applied to either end of said rotor.

8. An apparatus, according to claim 1, wherein said at least one ratchet assembly comprises two ratchet assemblies and wherein said rotor further comprises two end plates disposed at opposite ends of said rotor, each of said two endplates comprising ratchet engaging means for engaging one of said two ratchet assemblies, whereby two persons may employ said ratchet assemblies to apply torque to said rotor.

9. An apparatus, according to claim 1, wherein said elongate rotor comprises a quadrate tube.

10. An apparatus, according to claim 1, wherein said elongate rotor comprises a round tube.

11. An apparatus, according to claim 1, wherein said toothed blade comprises notches disposed between adjacent teeth of said toothed blade.

12. An apparatus, according to claim 1, wherein said toothed blade is flat.

13. An apparatus, according to claim 1, wherein said toothed blade is angled.

14. An apparatus, according to claim 1, where said toothed blade meets a radial line from a center of said tube at an angle of no less than about 40 degrees.

15. An apparatus, according to claim 1, wherein said ratchet assembly comprises a ratchet wrench and a handle extension, a length of said handle extension being about 90 centimeters.

16. An apparatus, according to claim 15, wherein said handle extension is welded to said ratchet wrench.

17. A toothed blade for engaging a carpet, said toothed blade for attachment to a rotor of a carpet stripping, apparatus, said toothed blade comprising a plurality of integral teeth for penetrating said carpet whereby a stripping force may be applied to said carpet by rotation of said rotor.

18. A toothed blade, according to claim 17, comprising notches disposed between adjacent ones of said teeth.

19. A toothed blade, according to claim 17, said toothed blade being substantially flat.

20. A toothed blade, according to claim 17, wherein said toothed blade is angled.
